(19) United States
(12) Patent Application Publication
(10) Pub. No.: US 2026/0030878 A1
(43) Pub. Date: Jan. 29, 2026

(54) IMAGE AND DEPTH SENSOR FUSION METHODS AND SYSTEMS

(71) Applicant: The Regents of the University of California, Oakland, CA (US)

(72) Inventors: Kshitiz Bansal, La Jolla, CA (US); Keshav Rungta, Santa Clara, CA (US); Dinesh Bharadia, San Diego, CA (US)

(21) Appl. No.: 18/994,390

(22) PCT Filed: Jul. 13, 2023
(86) PCT No.: PCT/US2023/070101

§ 371 Date: Jan. 14, 2025

Related U.S. Application Data
(60) Provisional application No. 63/389,687, filed on Jul. 15, 2022.

(51) Int. Cl. G06V 10/80; G06V 10/771

(52) U.S. Cl. CPC G06V 10/803; G06V 10/771; G06V 10/817

(57) ABSTRACT

A system for image fusion with a depth data includes an imaging system that provides image data with semantic information. A depth data sensor system provides depth data of objects in a field of view. A processor independently extracts the semantic information from the imaging system and combines it with the depth data by assigning weights. The processor generating a semantic-point encoding with depth data as central data. The central data can then play the primary role in object identification, while the system retains depth data and image data for use when the other is insufficient in view of the conditions during sensing. The depth data preferably is point cloud data, such as data from a mechanical radar that is processed to provide point cloud data or a radar system that provides point cloud data.

### PRIORITY CLAIM AND REFERENCE TO RELATED APPLICATION

The application claims priority under 35 U.S.C. § 119 and all applicable statutes and treaties from prior U.S. provisional application Ser. No. 63/389,687, which was filed Jul. 15, 2022.

### FIELD

A field of the invention concerns guidance systems that use camera and point cloud sensor data, such as radar data. Example applications of the invention include application to autonomous driving systems, robot guidance systems, and drone guidance systems.

### BACKGROUND

Existing self-driving systems can suffer from poor fusion of lidars and cameras that can perform poorly in cases of occlusions and adverse weather conditions. See, D. Feng, C. Haase-Schiitz, L. Rosenbaum, H. Hertlein, C. Glaeser, F. Timm, W. Wiesbeck, and K. Dietmayer, “Deep multi-modal object detection and semantic segmentation for autonomous driving: Datasets, methods, and challenges,” IEEE Transactions on Intelligent Transportation Systems, vol. 22, no. 3, pp. 1341-1360, 2020. 1, 3.

Such failures in cameras and lidars has turned interest to automotive radar-based sensing and camera-radar fusion systems. See, R. Nabati and H. Qi, “Centerfusion: Center-based radar and camera fusion for 3d object detection,” in Proceedings of the IEEE/CVF Winter Conference on Applications of Computer Vision, 2021, pp. 1527-1536; J. Kim, Y. Kim, and D. Kum, “Low-level sensor fusion network for 3d vehicle detection using radar range-azimuth heatmap and monocular image,” in Proceedings of the Asian Conference on Computer Vision, 2020; F. Nobis, M. Geisslinger, M. Weber, J. Betz, and M. Lienkamp, “A deep learning-based radar and camera sensor fusion architecture for object detection,” in 2019 Sensor Data Fusion: Trends, Solutions, Applications (SDF). IEEE, 2019, pp. 1-7.

While cameras provide rich texture and semantic information, failures occur in cases of long range, occluded objects and adverse weather conditions. [S. Chadwick, W. Maddern, and P. Newman, “Distant vehicle detection using radar and vision,” in 2019 International Conference on Robotics and Automation (ICRA). IEEE, 2019, pp. 8311-8317] Radars are capable of providing all-weather reliance, long range and occlusion-free detection, but struggle to recognize objects due to a lack of rich texture and semantic feature. See, A. Palffy, J. F. Kooij, and D. M. Gavrila, “Occlusion aware sensor fusion for early crossing pedestrian detection,” in 2019 IEEE Intelligent Vehicles Symposium (IV). IEEE, 2019, pp. 1768-1774; M. Holder, P. Rosenberger, H. Winner, T. D'hondt, V. P. Makkapati, M. Maier, H. Schreiber, Z. Magosi, Z. Slavik, O. Bringmann, et al., “Measurements revealing challenges in radar sensor modeling for virtual validation of autonomous driving,” in 2018 21st International Conference on Intelligent Transportation Systems (ITSC). IEEE, 2018, pp. 2616-2622; K. Bansal, K. Rungta, S. Zhu, and D. Bharadia, “Pointillism: accurate 3d bounding box estimation with multi-radars,” in Proceedings of the 18th Conference on Embedded Networked Sensor Systems, 2020, pp. 340-353.

Fusion between the camera and radar modalities has been performed in multiple ways. A late fusion approach combines individual detections from multiple modalities. This does not provide the ability for joint representation or joint feature extraction.

Existing early fusion approaches work in two ways. Some works project radar points onto to camera perspective view RGB image data. Operating in perspective view makes it harder to distinguish between small objects close to the sensor and large objects at a longer range. Others perform an inverse mapping of the camera's RGB image to radar's Bird's eye view (BEV) but an inverse mapping of the camera to BEV plane is ill-defined due to the lack of depth information in camera images.

Previous approaches that predominantly rely on the camera's perspective view, where the radar data is projected onto the camera image, use radar only as a secondary aid. Such methods have significant limitations, particularly in scenarios where objects are occluded in the camera image and hence fail to leverage the full potential of radar data. State-of-the-art approaches perform middle fusion or feature-level fusion. These approaches use multi-view feature aggregation from radar and image data [Jinhyeong Kim, Youngseok Kim, and Dongsuk Kum. Lowlevel sensor fusion network for 3d vehicle detection using radar range-azimuth heatmap and monocular image. In Proceedings of the Asian Conference on Computer Vision, 2020.]. For a particular object region proposal, features are fused from radar point clouds and camera images simultaneously. Unfortunately, the simultaneous feature extraction approach for camera and radar fusion has a heavy reliance on cameras. The performance severely degrades in cases where the camera input is degraded.

Existing lidar-camera based networks[Vora, Sourabh, Alex H. Lang, Bassam Helou, and Oscar Beijbom. “Pointpainting: Sequential fusion for 3d object detection.” In Proceedings of the IEEE/CVF conference on computer vision and pattern recognition, pp. 4604-4612. 2020.], are not designed to extract the necessary context required for handling the orders of magnitude higher sparsity and non-uniformity in radar point clouds (section 3).

### SUMMARY OF THE INVENTION

A preferred system for image fusion with a depth data includes an imaging system that provides image data with semantic information. A depth data sensor system provides depth data of objects in a field of view. A processor independently extracts the semantic information from the imaging system and combines it with the depth data by assigning weights. The processor generating a semantic-point encoding with depth data as central data. The central data can then play the primary role in object identification, while the system retains depth data and image data for use when the other is insufficient in view of the conditions during sensing.

The depth data preferably is point cloud data, such as data from a mechanical radar that is processed to provide point cloud data or a radar system that provides point cloud data. The processor preferably generates a bird's-eye-view (BEV) grid map of the point cloud data, a point feature map of the point cloud data, and image semantic maps. The processor preferably generates a semantic-point-grid point encoding with point cloud data designated as the central data and segmented with reference to the image semantic maps.

### BRIEF DESCRIPTION OF THE DRAWINGS

FIG. 1 is a schematic diagram of a preferred system for camera fusion with a point cloud source; and

FIGS. 2A-2D illustrate an example semantic assignment and correction conducted using multiple modalities according to the system of claim 1.

### DETAILED DESCRIPTION OF THE PREFERRED EMBODIMENTS

Preferred embodiments conduct sequential fusion by decoupling the simultaneous feature extraction from both the cameras and depth data sensors, such as point cloud sensors, e.g., radars and lidars. In the present methods and systems, features are sequentially extracted first from the camera and then propagated to radar (or other point cloud sensor) point clouds in a manner that pairs predetermined camera semantic data with point cloud sensor data. This permits all-weather reliable sensor fusion of point cloud data and camera images, even at long ranges, while using the point cloud sensor as the primary/central sensing modality.

Preferred methods and systems will be discussed with respect to radar as the depth data sensor system. Other point cloud sensors can be used, including lidar. Generally, depth data sensor systems, as used herein, refer to sensors that provide a plurality of discrete depth measurements of a surrounding environment. Examples include mechanical Radar/Radar with Raw data or Radar with point cloud data.

Preferred methods and systems conduct sequential feature extraction. This decouples the simultaneous feature extraction of the two modalities and applies a sequential fusion approach. Rich scene semantic information is extracted from cameras and then forwarded to radars, which assists object detection in the radar point clouds. Methods and systems apply input data encoding called SPG (Semantic-point-grid) encoding. The SPG encoding sequentially fuses semantic information from cameras with the radar point clouds. The encoding includes a (bird's eye view) BEV occupancy grid, a trained semantic segmentation network, and projects radar point clouds onto the semantically segmented image data via sensor calibration matrices.

A preferred system for image fusion with a depth data includes an imaging system that provides image data with semantic information. A depth data sensor system provides depth data of objects in a field of view. A processor independently extracts the semantic information from the imaging system and combines it with the depth data by assigning weights. The processor generating a semantic-point encoding with depth data as central data. The central data can then play the primary role in object identification, while the system retains depth data and image data for use when the other is insufficient in view of the conditions during sensing.

The depth data preferably is point cloud data, such as data from a mechanical radar that is processed to provide point cloud data or a radar system that provides point cloud data. The processor preferably generates a bird's-eye-view (BEV) grid map of the point cloud data, a point feature map of the point cloud data, and image semantic maps. The processor preferably generates a semantic-point-grid point encoding with point cloud data designated as the central data and segmented with reference to the image semantic maps.

Preferred embodiments of the invention will now be discussed with respect to experiments and drawings. Broader aspects of the invention will be understood by artisans in view of the general knowledge in the art and the description of the experiments that follows.

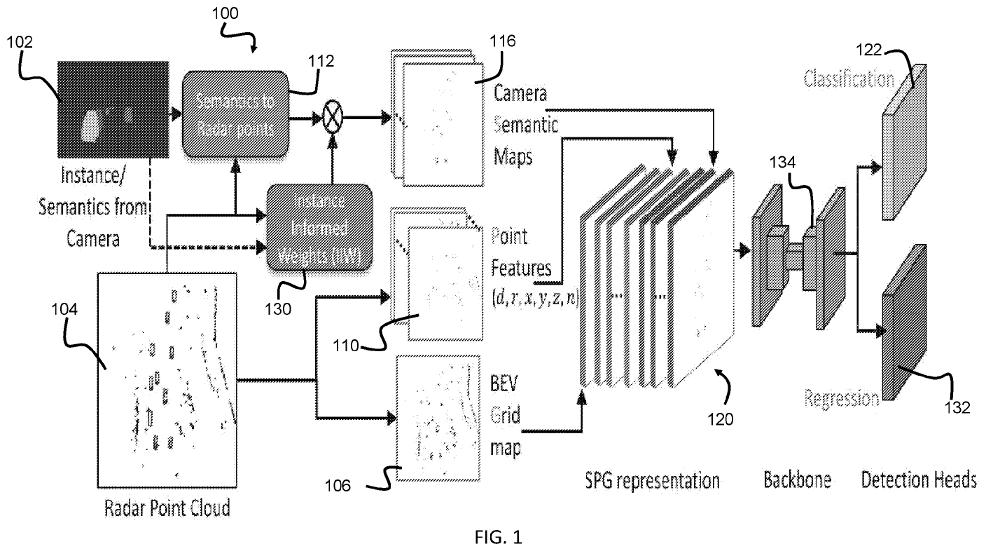

FIG. 1 is a schematic diagram of a preferred camera and point cloud fusion system 100 that serves as the depth data sensor system. A camera system 102 includes an image sensor to provide RGB data and processing that provides instance and semantic data. A radar sensor 104 provides radar point cloud data. A BEV occupancy grid is created 106.

The input representation of the sensor data has a significant impact on deep learning architecture's performance for object detection tasks. Specifically for radar data, high sparsity and non-uniformity make it extremely crucial to choose the correct view and feature representation. BEV representation is important to clearly separate objects at different depths, offering a clear advantage in cases of partially and completely occluded objects.

To generate a BEV representation in 106, project the radar points onto a 2D plane by collapsing the height dimension. The plane is then discretized into an occupancy grid. Each grid element is an indicator variable that gets a value of 1 if it contains a radar point otherwise it is represented as 0. This BEV occupancy grid preserves the spatial relationships between the different points of an unordered point cloud and stores radar data in a more structured format. The BEV occupancy grid provides order to the unordered radar point cloud. However, naively creating a BEV grid also discretizes the sensing space into grids which dissolves the useful information required for the refinement of bounding boxes. The grid module 106 retains that information by adding point-based features to the BEV grid as additional channels using module 120 with the output of modules 110 and 106. Selected predetermined information is added to the BEV grid. Preferably, the information includes cartesian coordinates, doppler and intensity information. The BEV grid input to the network is then defined as follows:

$$s : = ( I , d , r , x , z , y , n ) ( u , v )$$

Here, I represents the 2D occupancy grid where each grid element is parameterized as (u, ν). All the positions in I where radar points are present store 1 or else 0. d and r represents the doppler and intensity value of radar points. They help identify objects based on their speeds and reflection characteristics. (x, z) is the average depth and horizontal coordinate in the radar's coordinate system. To encode height information, generate height histograms by binning the height dimension (y) at 7 different height levels and creating 7 channels, one for each height bin. The cartesian coordinates (x, y, z) help in refining the predicted bounding box. The n channel contains the number of points present in that grid element. The value of n can be proportional to the surface area and reflected power which helps in refining bounding boxes. The number of points denote how strong the reflection is and that can help both in identifying the semantics of the object and refining the bounding box.

The BEV occupancy grid from module 106, along with radar point features 110 provided in parallel from the radar 104, represents all the information in radar point clouds in a well-structured format.

A direct projection of camera data to the BEV is non-trivial and challenging as camera lacks depth information. The system 100 uses a semantic grid encoding module 112 to independently extract information from the camera 102 in while being reliable in cases of camera uncertainty. The module 112 first extracts useful information from camera images in the form of scene semantics maps 116 and then an SPG motion 120 uses it to augment the BEV representation obtained from radar BEV module 106.

In contrast to fusing the features on a per-object basis, the SPG module 120 retains separation between information extraction from two modalities (radar and camera in this embodiment), hence performing reliably even when one input is degraded. A robust pre-trained instance segmentation network is used to obtain semantic masks from camera images of each object instance present in the scene, which are output from the camera system 102. Commercial pre-trained instance segmentation networks can be used, e.g., DeepLab trained on Cityscapes dataset.

To associate camera-based semantics to radar points, the module 112 creates separate maps for each output object class of the semantic segmentation network. These maps are of the same size as the BEV occupancy grid and get appended as semantic feature channels. To obtain the values of the semantic feature channels for each grid element, the module 112 transforms the radar points to the camera coordinates using camera intrinsic parameters. It then finds the nearest pixel in camera image to the transformed point and uses the semantic segmentation output of that pixel as the values of semantic feature channels in the SPG module 120.

For multiple radar points belonging to same grid element, an average is taken over semantic values. These feature channels contain the semantic information extracted from the camera 102, helping in the object detection from radar BEV occupancy grid provided by module 106. They effectively reduce the possible false positive predictions generated by radars, as the radars may get confused in identifying objects due to inherent non-uniformity in radar data.

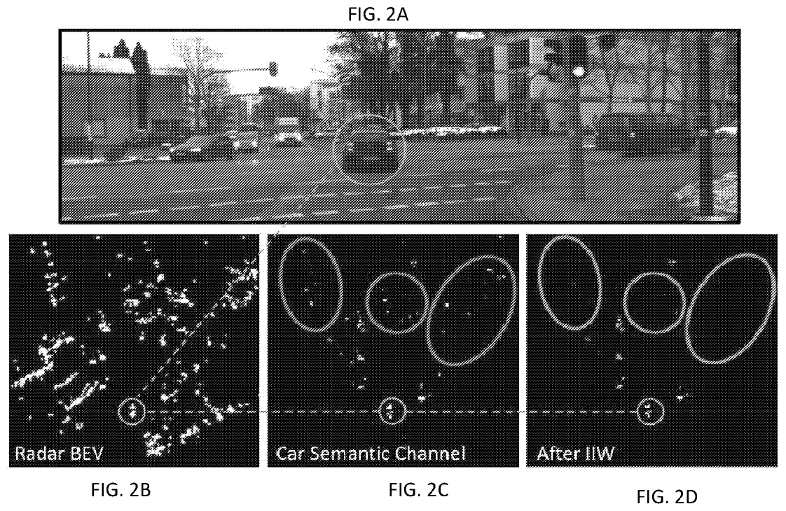

FIG. 2C shows an example of how the semantic features are encoded with the radar BEV grid, for the car identified in FIG. 2A. Module 130 applies Instance Informed Weights (IIW) to account for noise present in radar point clouds and errors in sensor extrinsic calibration. These noise and errors makes it challenging to correctly associate a given radar point with the corresponding pixel in the camera image. Specifically, there can be cases where because of these errors, where a point belonging to a background object like a building, gets projected on a foreground object like a car, which is in the same line of sight. In this case the point gets incorrectly associated with the semantics of the foreground object. The module 130 applies weighting scheme called IIW (instance informed weighing).

Radar points are first projected onto an instance segmentation map in module 112, where each object in the scene has its own instance mask. In doing so, for any given object, a list of points is generated that gets projected on its instance mask, consisting of both correct and incorrect projections caused by noise. These points are all assigned the same semantic information corresponding to that object's instance class and also an instance ID unique to that object instance in the module 130. Now, the problem of identifying the mis-projections corresponding to an object instance is reduced to finding the outliers in the subset of points having the same object ID and assigning them a lower importance weight. IIW assigned in 130 relies upon an insight that the number of misprojections would likely be lesser than the number of correct projections, as the mis-projections tend to happen mostly near the object edges.

The IIW 130 thus uses logic that presumes that the number of mis-projections is likely less than the number of correct projections because mis-projections tend to happen only near the object edges from far away objects.

To get the weight for a point n, a voting mechanism is used in module 130. For a point within the radius of α the module adds 1 and for a point outside radius α it subtracts 1. Mathematically, this can be expressed as the following tanh function:

$$\begin{matrix}S = {\sum }_{i} - tanh ( {k}_{2} ( ‖ {d}_{n} - {d}_{i} ‖ - α ) ) \\ = {\sum }_{i} tanh ( {k}_{2} ( α - ‖ {d}_{n} - {d}_{i} ‖ ) )\end{matrix}$$

The module 130 can use k₂ as a hyperparameter to tune the sharpness of tanh. Here, dᵢ is the cartesian coordinate of point i and ∥*∥ denotes the l₂ norm. When (∥dₙ−dᵢ∥−α) is positive, the −tanh (*) outputs a value closer to −1; and when it is negative, its value is closer to 1. To correct the incorrect projections per object, sum over the points selected using that object's instance mask (or the points with the same instance ID). So, each term in the sum is multiplied by 1(ρₙ=ρᵢ), an indicator function to identify points belonging to same instance ID ρₙ as that of point n

$${S}_{p} = {\sum }_{i} ( tanh ( {k}_{2} ( α - ‖ {d}_{n} - {d}_{i} ‖ ) ) * ( {p}_{i} = {p}_{n} ) )$$

To convert the value to the interval (0,1) use the sigmoid function. Hence, the final wₙ value becomes:

$$\begin{matrix}{w}_{n} = sigmoid ( {S}_{p} ) \\ = sigmoid [ {k}_{1} {\sum }_{i} ( tanh ( {k}_{2} ( α - ‖ {d}_{n} - {d}_{i} ‖ ) ) ( {p}_{i} = {p}_{n} ) ) ]\end{matrix}$$

k₁ is another hyperparameter to keep the value of weights close to 0 or 1. The module 130 implements the IIW by calculating the distances between all pairs of points via any suitable function. FIG. 2D shows how the IIW weighing module 130 corrects for the mis-projections in SPG encoding.

Artisans will notice that independent feature extraction is achieved because no radar points are filtered out, and information is retained from the camera and radar modalities. In cases where the camera based features become less informative, all objects in the scene are still visible to radars, which prevents any drastic drop in performance. The textural and high resolution information from cameras is condensed into semantic features which assists the all-weather, long range and occlusion robust sensing of radars.

SPG encoding 120 generates BEV maps, which are fed into a neural network for feature extraction 134 and bounding box prediction 122, 132. An example backbone used an encoder-decoder network with skip connections that has 4 stages of down-sampling layers and 3 convolutional layers at each stage. This allows extraction of features of different scales and combining them using skip connections during an up-sampling stage. An anchor box-based detection architecture can be used to generate predictions using a skip connections during an up-sampling stage. An anchor box-based detection architecture can be used to generate predictions using a classification 122 and a regression head 132. The classification head 122 in an example implementation uses focal loss [T.-Y. Lin, P. Goyal, R. Girshick, K. He, and P. Dollar, “Focal loss for dense object detection,” in Proceedings of the IEEE international conference on computer vision, 2017, pp. 2980-2988]\ to deal with sparse radar point clouds, and the regression head 132 uses Smooth L1 loss.

### EXAMPLE IMPLEMENTATION

Image segmentation network used in camera system 102: We utilized a pre-trained maskRCNN [K. He, G. Gkioxari, P. Dollir, and R. Girshick, “Mask r-cnn,” in Proceedings of the IEEE international conference on computer vision, 2017, pp. 2961-2969] model from pytorch's model zoo for our image segmentation network due to its accuracy and generalizability. However, depending on the use case, a faster alternative model can also be selected. The present approach remains agnostic to the chosen network type.

Metric: We use BEV average precision (AP) as our main metric in our evaluation with an IoU threshold of 0.5 to determine True Positives.

Either a mechanical Navtech CTS 350-X radar or an Astyx radar along with forward-facing cameras were used. For mechanical radar (but not needed for point cloud radar), the radar data is stored as 2D intensity maps, without any height information. The camera is only facing forward, so we crop out the intensity maps to only keep the forward direction. The labels are filtered accordingly. The present system uses point clouds as input in order to perform SPG encoding. As the mechanical radar input is present in form of intensity maps, we use CFAR [M. dᵢ Bisceglie and C. Galdi, “Cfar detection of extended objects in high-resolution sar images,” IEEE Transactions on geoscience and remote sensing, vol. 43, no. 4, pp. 833-843, 2005] filtering technique to convert the intensity maps to 2D point clouds. We use the height of the sensor as the height coordinate for data, in order to get a 3D point cloud.

While preferred embodiments have been described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A system for image fusion with a depth data, comprising:
an imaging system that provides image data with semantic information;
a depth data sensor system that provides depth data of objects in a field of view; and
a processor, wherein the processor independently extracts the semantic information from the imaging system and combines it with the depth data by assigning weights, the processor generating a semantic-point encoding with depth data as central data.

2. The system of claim 1, wherein the depth data comprises point cloud data.

3. The system of claim 2, wherein the processor generates a bird's-eye-view (BEV) grid map of the point cloud data, a point feature map of the point cloud data, and image semantic maps, the processor generating a semantic-point-grid point encoding with point cloud data designated as the central data and segmented with reference to the image semantic maps.

4. The system of claim 2, wherein the processor sends the central data and image data to a trained network.

5. The system of claim 4, wherein the trained network comprises a classification network and a regression network

6. The system of claim 2, wherein the processor projects points of the point cloud data onto a 2D plane by collapsing the height dimension and then discretizes the plane into an occupancy grid.

7. The system of claim 6, wherein the occupancy grid preserves spatial relationships between different points of the point cloud data.

8. The system of claim 6, wherein the processor adds point-based features to the BEV grid map as additional channels.

9. The system of claim 8, wherein the point-based features comprise at least two of cartesian coordinates, doppler and intensity information.

10. The system of claim 9, wherein the point-based features comprise all three of cartesian coordinates, doppler and intensity information.

11. The system of claim 6, wherein the processor encodes height data by generating height histograms that bin a plurality of height level bins and creates a channel for each height level bin.

12. The system of claim 1, wherein the processor maintains separation and independence of the point feature map of the point cloud data and camera semantic maps such that either can be used to train a network.

13. The system of claim 1, comprising an instance informed weight module to correct semantic maps for any errors due to noise or miscalibration.

14. The system of claim 13, wherein the instance informed weight module presumes that a number of mis-projections is less than the number of correct projections.

15. The system of claim 14, wherein the instance informed weight module obtains a weight for a point n by a voting mechanism that assigns, for a point within a radius of α, the module adds 1 and for a point outside radius α it subtracts 1.

16. The system of claim 15, wherein the voting mechanism follows the following tanh function
$$\begin{matrix}S = {\sum }_{i} - tanh ( {k}_{2} ( ‖ {d}_{n} - {d}_{i} ‖ - α ) ) \\ = {\sum }_{i} tanh ( {k}_{2} ( α - ‖ {d}_{n} - {d}_{i} ‖ ) )\end{matrix}$$
wherein k₂ is a hyperparameter to tune the sharpness of tanh, dᵢ is the cartesian coordinate of point i and ∥*∥ denotes the l₂ norm.

17. The system of claim 16, wherein when (∥dₙ−dᵢ∥−α) is positive, the −tanh (*) outputs a value closer to −1; and when it is negative, its value is closer to 1.

18. The system of claim 17, wherein, to correct incorrect projections per object, a sum over points selected using an object's instance mask and each term in the sum is multiplied by 1(ρₙ=ρᵢ), an indicator function to identify points belonging to same instance ID ρₙ as that of point n
$${S}_{p} = {\sum }_{i} ( tanh ( {k}_{2} ( α - ‖ {d}_{n} - {d}_{i} ‖ ) ) * ( {p}_{i} = {p}_{n} ) ) .$$

19. The system of claim 17, wherein a sigmoid function is used to convert a value to an interval, and a final wₙ value becomes:
$$\begin{matrix}{w}_{n} = sigmoid ( {S}_{p} ) \\ = sigmoid [ {k}_{1} {{\sum }_{i}}_{} ( tanh ( {k}_{2} ( α - ‖ {d}_{n} - {d}_{i} ‖ ) ) ( {p}_{i} = {p}_{n} ) ) ]\end{matrix}$$
wherein k₁ is another hyperparameter to keep the value of weights close to 0 or 1.

20. The system of claim 1, wherein the depth data sensor system comprises radar.
